(19) United States
(12) Patent Application Publication
(10) Pub. No.: US 2024/0349654 A1
(43) Pub. Date: Oct. 24, 2024

(54) SYSTEMS, DEVICES AND METHODS FOR CONTROLLING GROWTH OF A PLANT

(71) Applicant: SYMPHONI BIOTECH INC., LÉVIS (CA)

(72) Inventor: Vincent LÉVESQUE, Laval (CA)

(73) Assignee: SYMPHONI BIOTECH INC., LÉVIS, QC (CA)

(21) Appl. No.: 18/684,664

(22) PCT Filed: Aug. 18, 2022
(86) PCT No.: PCT/CA2022/051253

§ 371 Date: Feb. 17, 2024

Related U.S. Application Data
(60) Provisional application No. 63/234,282, filed on Aug. 18, 2021.
(60) Provisional application No. 63/258,000, filed on Oct. 20, 2021.

(51) Int. Cl. A01G 7/04; G01N 21/64

(52) U.S. Cl. CPC A01G 7/045; G01N 21/6486; G01N 2021/6421

(57) ABSTRACT

Systems, methods and devices for controlling the growth of a plant are described herein. The systems include a photonic sensor and a computing device communicatively coupled to the photonic sensor. The photonic sensor includes an excitation pulse generator configured to generate an excitation pulse of light and direct it towards a target area of a plant. The sensor also includes a lens configured to receive fluorescent light from the target area of the plant and direct the fluorescent light to a focal point, a plurality of optical filters, each being configured to selectively transmit a selected wavelength range of the fluorescent light, the selected wavelength range indicating a molecular activity of the plant, and a photodiode configured to determine an intensity of the selected wavelength range of fluorescent light and convert the measured intensity to a digital signal to be transmitted as molecular activity data to the computing device.

### CROSS-REFERENCE TO RELATED APPLICATIONS

The present application claims priority to U.S. 63/234,282 filed on Aug. 18, 2021 and to U.S. 63/258,000 filed on Oct. 20, 2021. These documents are hereby incorporated by reference in their entirety.

### TECHNICAL FIELD

This disclosure relates generally to systems, devices and methods for controlling growth of a plant, and more specifically, to systems, devices and methods for semi-autonomously controlling growth of a plant.

### BACKGROUND

The world's population continues to increase and, at a pace of 0.9% growth per year, is expected to reach 10 billion individuals by 2050. With this tremendous growth, global food security is becoming a great challenge.

One potential path to solving this issue of global food security is increasing agricultural efficiency and productivity. By increasing agricultural efficiency and productivity, more food may be produced using less of the earth's resources. Soil-less agricultural methods, such as but not limited to hydroponic, aeroponic or ultraponic methods, offer tremendous potential in this area.

Soil-less techniques increase efficiency and productivity of food production mostly due to advanced technological features that maintain plants in an optimal growing state while optimizing the quantity of resources supplied to the plant. Plant nutrition and atmospheric conditions are currently well understood, however, improvements in lighting technologies are needed. Advanced lighting technologies have the potential to increase productivity and efficiency of soil-less growing techniques and technologies as well as more traditional soil-based growing techniques and technologies. Currently, most lighting technologies attempt to replicate photosynthetic active radiation, or the sun, delivered to the plant. However, other lighting technologies may be useful in increasing agricultural efficiency and productivity of food production.

Chlorophyll fluorescence is light re-emitted by chlorophyll molecules in plants, algae and bacteria as they return from excited to non-excited states. Chlorophyll fluorescence can be used as an indicator of photosynthetic energy conversion, and therefore plant health, in plants, algae and bacteria. Specifically, variations in the fluorescence re-emitted by chlorophyll molecules has been previously been linked to various stresses that the plant is undergoing, such as but not limited to lack of water. Currently, scientific literature demonstrates that it may be possible to link other plant stresses to chlorophyll fluorescence. Unfortunately, few technologies have been developed that link chlorophyll fluorescence to other factors that affect plant growth, such as but not limited to environmental factors and biochemical factors.

Accordingly, there is a need for new technologies for understanding of relationships between chlorophyll fluorescence and various environmental and biochemical factors that affect plant growth.

### SUMMARY

In accordance with a broad aspect, a photonic sensor for controlling growth of a plant is described herein. The photonic sensor includes an excitation pulse generator configured to generate an excitation pulse of light and direct the excitation pulse of light towards a target area of a plant. The photonic sensor also includes a lens configured to receive fluorescent light from the target area of the plant and direct the fluorescent light to a focal point. The photonic sensor also includes a plurality of optical filters, each optical filter being configured to selectively transmit a selected wavelength range of the fluorescent light from the target area of the plant. The selected wavelength range indicates an activity and/or a concentration of at least one molecule of the plant. The photonic sensor also includes a photodiode configured to determine an intensity of the fluorescent light having the selected wavelength range and convert the measured intensity to a digital signal to be transmitted as molecular activity data to a computing device.

In at least one embodiment, each of the optical filters is selected based on wavelength spikes corresponding to different molecules of the plant.

In at least one embodiment, the molecule of the plant is selected from Chlorophyl A and B, Carotenoids, Phycocyanin and Phycoerythrin and others.

In at least one embodiment, the photonic sensor also includes a filter assembly comprising a housing configured to support each of the plurality of optical filters, the filter assembly being configured to position each of the optical filters at or near the focal point.

In at least one embodiment, the filter assembly includes at least one motor coupled to the housing and configured to rotate the housing about a vertical axis.

In at least one embodiment, the filter assembly includes two step motors; two filter housings, each filter housing being coupled to one of the motors and configured to rotate about a vertical axis; and eight optical filters housed in each of the filter housings.

In at least one embodiment, the filter housings are configured to rotate simultaneously in opposite directions.

In at least one embodiment, each filter housing is configured to rotate each optical filter into a path of the light from the plant at the focal point.

In at least one embodiment, the filter assembly is adjustable to position the optical filters at the focal point.

In accordance with a broad aspect, a system for controlling growth of a plant is described herein. The system includes a photonic sensor configured to: direct an excitation pulse of light towards a target area of the plant; receive fluorescent light from the target area of the plant; selectively transmit a selected wavelength range of the fluorescent light from the target area of the plant, the selected wavelength range indicating a molecular activity of the plant; determine an intensity of the fluorescent light having the selected wavelength range; convert the measured intensity to a digital signal; transmit the digital signal to a computing device as plant molecular activity data; and a computing device communicatively coupled to the photonic sensor, the computing device configured to: receive the plant molecular activity data from the photonic sensor, the plant molecular activity data indicating molecular activity or a molecular concentration of one or more molecules; and when the plant molecular activity data is below a threshold value: determine a command based on the data to change a parameter of the system; and transmit the command indicating the change of the parameter to a controller to control the growth of the plant.

In at least one embodiment, the system also includes at least one environmental sensor configured to: measure at least one environmental factor; and transmit environmental data indicating the environmental factor to the computing device.

In at least one embodiment, the computing device is configured to determine the command based on the plant molecular activity data and the environmental data.

In accordance with a broad aspect, a method of controlling growth of a plant is described herein. The method includes directing an excitation pulse of light towards a target area of the plant; receiving fluorescent light from the target area of the plant; selectively transmitting a selected wavelength range of the fluorescent light from the target area of the plant, the selected wavelength range indicating a molecular activity of the plant; determining an intensity of the fluorescent light having the selected wavelength range; converting the measured intensity to a digital signal; and transmitting the digital signal to a computing device as plant molecular activity data.

In accordance with another broad aspect, a growth chamber for a controlling growth of a plant is described herein.

These and other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIG. 1 is a block diagram of a growth chamber system, according to at least one embodiment described herein.

FIG. 2A is a perspective view from below of the photonic sensor of FIG. 2.

FIG. 2B is a perspective view from above of the photonic sensor of FIG. 2.

FIG. 3 is an exploded view of a photonic sensor of the system of FIG. 1, according to at least one embodiment described herein.

FIG. 4A is a perspective view of a growth chamber, according to one embodiment described herein.

FIG. 4B is an exploded view of the growth chamber of FIG. 4A.

FIG. 5A is a perspective view of another growth chamber, according to one embodiment described herein.

FIG. 5B is an exploded view of the growth chamber of FIG. 5A.

FIG. 6A is a perspective view of another growth chamber, according to one embodiment described herein.

FIG. 6B is an exploded view of the growth chamber ion of FIG. 6A.

Further aspects and features of the example embodiments described herein will appear from the following description taken together with the accompanying drawings.

### DETAILED DESCRIPTION

The various embodiments described herein generally relate to methods (and associated systems configured to implement methods) for controlling growth of a plant. The term “plant”, as used herein, broadly refers to any organism of the kind exemplified by trees, shrubs, herbs, grasses, ferns, and mosses, absorbing water and inorganic substances through its roots, and synthesizing nutrients in its leaves by photosynthesis using the green pigment chlorophyll. “Plant” may be used to refer to plants at any stage of a plant lifecycle, including but is not limited to seed, seedling or mature plant.

Chlorophyll is a green pigment, present in all green plants and in cyanobacteria, responsible for the absorption of light to provide energy for photosynthesis.

The systems and methods described herein may be used for controlling the growth of plants growing in traditional soil-based growing systems and in soil-less growing systems, such as but not limited to aeroponic and hydroponic growing systems.

Herein the term “aeroponic” refers to a plant-cultivation technique in which the roots of the plant hang suspended in the air while nutrient solution is delivered to them in the form of a fine mist.

Herein the term “hydroponic” refers to a plant-cultivation technique in which the plants are grown without soil. For example, the roots of the plant may be in a liquid, such as but not limited to water, and optionally supported by an inert physical substance such as but not limited to sand or gravel.

Various systems, apparatus and methods are described below to provide an example of at least one embodiment of the claimed subject matter. No embodiment described below limits any claimed subject matter and any claimed subject matter may cover systems, apparatus and methods that differ from those described below. The claimed subject matter are not limited to systems, apparatus and methods having all of the features of any one system, apparatus and/or method described below or to features common to multiple or all of the systems, apparatus or methods described below. It is possible that a system, apparatus and method described below is not an embodiment of any claimed subject matter. Any subject matter that is disclosed in a system, apparatus or method described herein that is not claimed in this document may be the subject matter of another protective instrument, for example, a continuing patent application, and the applicant(s), inventor(s) and/or owner(s) do not intend to abandon, disclaim, or dedicate to the public any such invention by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description and the drawings are not to be considered as limiting the scope of the embodiments described herein in any way, but rather as merely describing the implementation of the various embodiments described herein.

It should be noted that terms of degree such as “substantially”, “about” and “approximately” as used herein mean a reasonable amount of deviation of the modified term such that the end result is not significantly changed. These terms of degree should be construed as including a deviation of the modified term, such as 1%, 2%, 5%, or 10%, for example, if this deviation does not negate the meaning of the term it modifies.

It should be noted that the term “coupled” used herein indicates that two elements can be directly coupled to one another or coupled to one another through one or more intermediate elements.

The following description is not intended to limit or define any claimed or as yet unclaimed subject matter. Subject matter that may be claimed may reside in any combination or sub-combination of the elements or process steps disclosed in any part of this document including its claims and figures. Accordingly, it will be appreciated by a person skilled in the art that an apparatus, system or method disclosed in accordance with the teachings herein may embody any one or more of the features contained herein and that the features may be used in any particular combination or sub-combination that is physically feasible and realizable for its intended purpose.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example and without limitation, the programmable computers may be a server, network appliance, embedded device, computer expansion module, a personal computer, laptop, personal data assistant, cellular telephone, smart-phone device, tablet computer, a wireless device or any other computing device capable of being configured to carry out the methods described herein.

In some embodiments, the communication interface may be a network communication interface. In embodiments in which elements are combined, the communication interface may be a software communication interface, such as those for inter-process communication (IPC). In still other embodiments, there may be a combination of communication interfaces implemented as hardware, software, and combination thereof.

Program code may be applied to input data to perform the functions described herein and to generate output information. The output information is applied to one or more output devices, in known fashion.

Each program may be implemented in a high level procedural or object oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g. ROM, magnetic disk, optical disc) readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the systems, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloading, magnetic and electronic storage media, digital and analog signals, and the like. The computer useable instructions may also be in various forms, including compiled and non-compiled code.

Recently, there has been a growing interest in developing new systems and methods for controlling growth of a plant. In at least one embodiment, the systems described herein include a photonic sensor configured to measure fluorescence emitted by one or more plants in response to receiving a pulse of light from the photonic sensor.

In at least one embodiment, the photonic sensor comprises one or more optical filters configure to transmit light within a selected portion (i.e. wavelength ranges) of the optical spectrum that has been determined to indicate a concentration and/or an activity of at least one molecule of the plant while rejecting light of other portions of the optical spectrum.

In at least one embodiment, the photonic sensor comprises a system for changing a position of one or more optical filters. Changing the position of the one or more optical filters provides for the photonic sensor to transmit light at various selected wavelength ranges of the optical spectrum while rejecting light of other portions of the optical spectrum.

In at least one embodiment, the photonic sensor is configured to measure an intensity of the light received by the sensor at the selected wavelength range of the optical spectrum.

In at least one embodiment, the photonic sensor is configured to send an excitation pulse of light towards the plant. The excitation pulse of light excites a molecule such as but not limited to chlorophyll within the plant, which then fluoresces. The photonic sensor is configured to measure the fluorescence of the molecule emitted, such as but not limited to chlorophyll. For example, in at least one embodiment, the molecule may fluoresce in a range of the optical spectrum of about 650 to about 800 nm.

In at least one embodiment, the intensity of the emitted fluorescence of the molecule measured by the photonic filter may indicate a concentration and/or an activity of a molecule of the plant. For example, the fluorescence of the molecule measured by the photonic filter may indicate a stress that the plant is undergoing or otherwise a general health of the plant (i.e., may be an indicator of photosynthetic energy conversion in the targeted area of the plant).

In at least one embodiment, the intensity of the emitted fluorescence of the molecule measured by the photonic filter at a pre-determined wavelength may indicate a concentration and/or an activity of a molecule of the plant. For example, the intensity of the fluorescence measured by the photonic filter at a selected wavelength range may indicate a stress that the plant is undergoing.

In at least one embodiment, after transmitting the intensity measurement from the photonic sensor to a computing device, the computing device is configured command a control system to change one or more environmental factors, such as but not limited to lighting conditions for the plant(s).

In at least one embodiment, the systems described herein include multiple environmental sensors that measure environmental conditions of the system, the environmental sensors including but not limited to a pH sensor, a CO₂ and/or O₂sensor, a humidity sensor, a temperature sensor, and the like.

In at least one embodiment, the systems described herein are configured to control the growth of plants based on measurements by the photonic sensor(s), and/or the environmental sensors, and/or one or more cameras. For example, in at least one embodiment, the systems described herein include a computing device configured to simultaneously receive data from the photonic sensor(s) and/or the environmental sensor(s) and/or camera(s) and command peripheral devices or subsystems based on this received data, such as but not limited to watering subsystems and/or lighting subsystems, to control the growth of the plants.

In at least one embodiment, the systems described may be automated. For instance, the following functions may be fully or partially automated: changing the optical filters in the photonic sensor, emitting a pulse of light to excite at least a portion of a plant for a selected period of time, measure an intensity of light emitted from the plant(s) and convert the measurement into digital data, transmitting the digital data to a computing device (the digital data including data from the photonic sensor(s) and/or the environmental sensor(s) and/or camera(s)), configuring the data, analyzing the data, adapting conditions of the system (such as but not limited to watering subsystems and/or lighting subsystems) depending on results calculated by the computing device.

In at least one embodiment, there is provided a feedback control system of the lighting based on the plant stress read from its chlorophyll fluorescence.

In at least one embodiment, the systems described herein include a growth chamber housing one or more plants, the growth chamber including one or more subsystems (e.g. watering subsystems and/or lighting subsystems) communicatively coupled to a computing device. In at least one embodiment, the computing device is included in the growth chamber. In at least one embodiment, the computing device is external to the growth chamber.

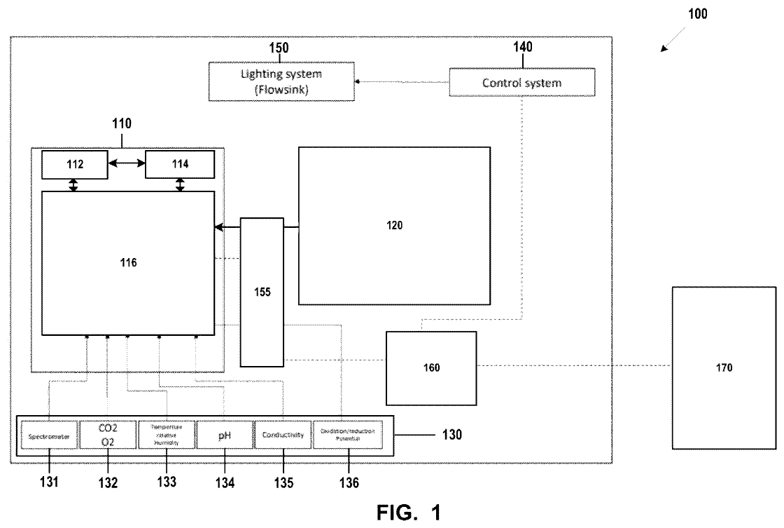

Turning to the figures, referring to FIG. 1, there is shown a block diagram of a system 100 for controlling growth of a plant, according to at least one embodiment. System 100 can include a computing device 110, at least one photonic sensor 120, a plurality of environmental sensors 130, a control system 140 and a lighting system 150. Although only one photonic sensor 120 is shown in FIG. 1, and only one of each different type of the environmental sensors 130 is shown in FIG. 1, it is possible for the system 100 to include more photonic sensors 120 and/or more of each of the different types of environmental sensors 130.

Growth of a plant can be controlled by one or more computing devices 110 based on data and/or information received from the photonic sensor 120 and/or environmental sensors 130. For example, computing device 100 may receive data and/or information from photonic sensor 120 regarding molecular activity (i.e. a concentration and/or an activity of a molecule) of the plant (e.g. indicating plants stresses through chlorophyll light emission). For example, computing device 100 may receive data and/or information from environmental sensors 130 providing details regarding, for example, environmental factors within the system 100 when the information on the molecular activity of the plant is collected by the photonic sensor 120. Environmental factors may include but are not limited to temperature, humidity, pH, conductivity, etc. of the system 100.

Computing device 110 may include a storage unit 112, a processing unit 114 and a communication interface 116. The storage unit 112 can store data generated by the processing unit 114 and data received from the photonic sensors 120, environmental sensors 130 (not shown in FIG. 1), control system 140, and other external devices 170. For example, the storage unit 112 can store data in respect of the operation of the system 100, such as plant molecular activity data of the photonic sensors 120, environmental condition data of the environmental sensors 130, lighting system data, control system data, and the like.

In some embodiments, the storage unit 112 can instead be separate from computing device 110 and be accessible to the computing device 110 via the communication network 160.

The processing unit 114 can control the operation of the computing device 110. The processing unit 114 may be any suitable processing units, controllers or digital signal processors that can provide sufficient processing power depending on the configuration, purposes and requirements of the computing device 110. In some embodiments, the processing unit 114 can include more than one processing unit with each processing unit being configured to perform different dedicated tasks. The processing unit 114 together with photonic sensor 120, control system 140 and the lighting system 150 to the control growth of the plant.

The communication interface 116 facilitates communication between the computing device 110 and the other components of the system 100, such as the photonic sensor 120, the environmental sensors 130, control system 140, external devices 170 and any other sensor units and devices, via the communication network 155.

Computing device 110 is configured to receive inputs from the photonic sensor 120 and/or environmental sensors 130 and determine an output for controlling growth of the plant. For example, computing device 100 can, via a communication network 155, communicate with external device 170.

Some components of the server 120 may be virtualized in a cloud computing infrastructure. A cloud computing infrastructure can improve reliability and maintenance of the server. A cloud computing infrastructure can also allow a system 100 to manage client information and provide access control across a plurality of facilities.

To control growth of the plant, the processing unit 114 can generate commands for the control system 140 based on data received from the photonic sensor 120 and/or the environmental sensors 130 and/or data stored in the server storage unit 112 and/or an algorithm by processing unit 114 or an external device 170. In addition, the computing device 110 can integrate and control several subsystems, that is, other sensor units and output devices. These subsystems can include communication network 155.

To determine whether or not to generate a command, the processing unit 114 can process data received from the photonic sensors 120 and/or the environmental sensors 130. In one embodiment, the processing unit 114 can determine the command to generate based on comparison of the data received from the photonic sensors 120 and/or the environmental sensors 130 stored in storage 112. In another embodiment, the processing unit 114 can determine the command to generate based on an algorithm based on historical data received from the photonic sensors 120 and/or the environmental sensors 130. The algorithm may be run by the processor 114 or processor 114, via communication interface 116 and network 155, may transmit data received from the photonic sensors 120 and/or the environmental sensors 130 to an external device 170 and receive a command from the external device 170.

The processing unit 114 can generate a command and transmit the command to, for example, the control system 140. For example, the processing unit 114 can determine that the intensity of light of the lighting system 150 need to increase in order to improve the molecular activity of the plant. The command can be transmitted to the control system by communication interface 116 via network 155, and optionally via server 160, for the control system 140 to control the lighting system 150.

It should be understood that the systems and methods described herein can involve modeling the behavior of one or more plants as they are growing in real-time. For example, some embodiments described herein may involve predicting the growth of one or more plants.

The systems and methods described herein may use artificial intelligence or machine learning methods to train (i.e., generate or build) models for predicting one or more properties of one or more plants as they are growing. For example, some embodiments described herein may involve receiving various data associated with the environment of the plant, such as but not limited to the data from the environmental sensors noted above, and/or various data from the photonic sensor regarding the health of the plant(s) and/or image data from one or more cameras capturing images (e.g. still images and/or video) of the one or more plant(s). Some embodiments described herein may involve identifying data relevant to the health and/or growth of the plant and training a model using the environmental data, the plant health data and/or the image data. The systems and methods described herein may generate models that do not rely on explicit instructions or programming. Instead, the described systems and methods may generate models that utilize patterns or inferences determined from training data.

The systems and methods described can also involve using trained models for various purposes. For example, the trained models may be used to predict the health or growth of one or more plants based on environmental data received from various sensors. In some embodiments, the trained models may be used to optimize the efficiency of delivery of nutrients to the plant(s). For example, the trained models may be used to determine the efficiency of various settings to optimize the health and/or growth of the plant(s), such as but not limited to during different growth cycles of the plant(s). In some embodiments, the trained models may be used to evaluate nutrient availability to the plant(s) and identify the nutrients that have a greater impact on the health and/or growth of the plant(s), such as but not limited to during different growth cycles of the plant(s). Similarly, in some embodiments, the trained models may be used to evaluate settings and eliminate parameters that have a reduced impact or no impact on the health and/or growth of the plant(s), such as but not limited to during different growth cycles of the plant(s).

For example, without limiting the forgoing, the trained models may be used to evaluate the spectrum of light provided to the plant(s) and assess the health of the plant(s), such as but not limited to based on chlorophyll concentration of the plant(s), at various times, such as but not limited to during growth stages of the plant, to optimize light delivery to the plant.

It should be understood that although a single lighting system 150 is shown in FIG. 1, more than one lighting system 150 may be present in system 100. Further, it should also be understood that other peripheral subsystems may be included and may be controlled by the computing device 110, via control system 140. For instance, additional subsystems may include but are not limited to a watering subsystem, a nutrient subsystem, and an environmental controller for controlling ambient temperature and relative humidity.

As noted above, the processing unit 114 can generate commands for subsystems (e.g. lighting system 150) based on analysis of the data received from the photonic sensor 120 and/or the environments sensors 130.

Commands can be triggered based on any indicator, including growth indicators stored in storage 114. For example, growth indicators may indicate that the molecular activity of the plant needs to improve. Various growth indicators can be stored, including but not limited to normalized difference vegetation index (NDVI) data and evolution of CO₂ and O₂.

Environmental sensors 130 may be positioned adjacent to or neighboring to the plant and measure one or more environmental conditions.

For example, environmental sensors 130 may be able to measure pH (e.g. of water in hydroponic systems), temperature (e.g. of air and water), humidity of air, electroconductivity of water, reduction potential (i.e. redox potential), dissolved oxygen in water, the light intensity with the photodiode, the light spectrum emitted from the lighting system (e.g. with a spectrometer). In at least one embodiment, additional data can be provided by to computing device 100 as image data (e.g. of a canopy of the plant) with a camera, such as but not limited to a camera of the photonic sensor 120.

For example, referring to FIG. 1, environmental sensors 130 may include

one or more spectrophotometer 131, a CO₂ and/or O₂ sensor 132, a temperature/relative humidity sensor 133, a pH sensor 134, a conductivity sensor 135 and/or an oxidation/reduction potential (ORP) sensor 136 and/or one or more photocells.

In at least one embodiment, spectrometer 131 is positioned at a height of the canopy among the plants within a growing chamber, such as but not limited to growing chambers 400, 500, 600 described herein. Spectrometer 131 points toward the lights of the growing chamber to perceive the same light signature as the plants. In at least one embodiment, the spectrometer 131 can use that information in a feedback loop system with the light. In at least one embodiment, the feedback loop system can provide for confirmation of the intended light spectrum perceived by the plants. In at least one embodiment, the system can store the exact signature of light perceived by the plants during a growth cycle for post analyses.

In at least one embodiment, CO₂ and/or O₂ sensor 132 and the temperature/relative humidity sensor 133 are positioned among the plants within a growing chamber, optionally as close as possible to the leaves of the plants, to provide accurate measurements of the air environment around the plant. Data captured by CO₂ and/or O₂ sensor 132 and the temperature/relative humidity sensor 133 can provide for maintaining appropriate levels of CO₂ and/or O₂ levels in the growing chamber, temperature and relative humidity in the growing chamber, and for providing an optimal environment for plant growth. Data captured by CO₂ and/or O₂ sensor 132 and the temperature/relative humidity sensor 133 can be stored for post analyses.

In at least one embodiment, pH sensor 134, conductivity sensor 135 and/or ORP sensor 136 provide measurements of the water for soilless plants. In at least one embodiment, pH sensor 134 measures pH of the water. Balancing the pH level of the water can be achieve based on the measurements collected. Nutrients can be provided to the water, for example, to adjust the pH of the water. Similarly, conductivity sensor 135 measures conductivity of water. These measurements can be compared to threshold values or desired values, and, for example, nutrients can be added to the water to correct the conductivity when necessary. for optimal levels of nutrients in water. In at least one embodiment, ORP sensor 136 may provide for monitoring and/or limiting microbial activity within the water. For example, when the ORP sensor 136 detects ORP values above a threshold value, a presence of viruses and/or bacteria in the water can be detected. Viruses and/or bacteria present in the water may shorten a lifespan of dissolved O₂ in the water, thus reducing the amount of oxygen available at plants. Again, for each of pH sensor 134, conductivity sensor 135 and/or ORP sensor 136, measurements can be stored as data and used for post analyses.

In at least one embodiment, one or more photocells are present adjacent to the plant(s) to provide readings of the spectrum of light received by the plant over time.

Computing device 110 is communicatively coupled to each of the at least one photonic sensor 120, the plurality of environmental sensors 130, the control system 140 and the lighting system 150 via communication network 155. In at least one embodiment, computing device 110 may be communicatively coupled to the at least one photonic sensor 120, the plurality of environmental sensors 130, control system 140 and/or the lighting system 150 by a local server 160. In at least one embodiment, computing device 110 may also be communicatively coupled to an external server 170.

In some embodiments, more than one communication network 155 can be provided. The communication network 155 may be any network capable of carrying data, including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX, Zigbee, Z-Wave, Bluetooth®, Bluetooth® Low Energy, Long Range “LoRa”), SS7 signaling network, fixed line, local area network, wide area network (e.g., Long Range Wide Area Network “LoRaWAN”), and others, including any combination of these, capable of interfacing with, and enabling communication between the server 120, the locking devices 110, and user computing devices (not shown in FIG. 1).

In some embodiments, the communication network 155 can be physically connected to the server 160. In some embodiments, the server 160 may be equipped with a wireless communication interface to enable wireless communications according to a Wi-Fi protocol (e.g. IEEE 802.11 protocol or similar).

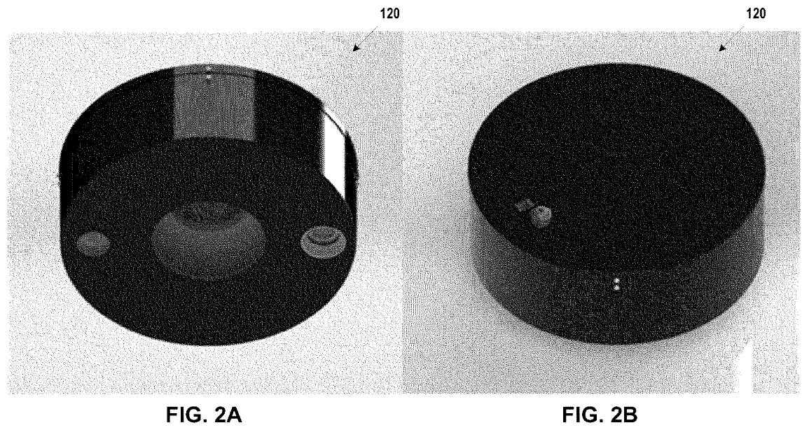

Turning to FIGS. 2A and 2B, illustrated therein is perspective view from below and a perspective view from above, respectively, of a photonic sensor 120 according to at least one embodiment described herein.

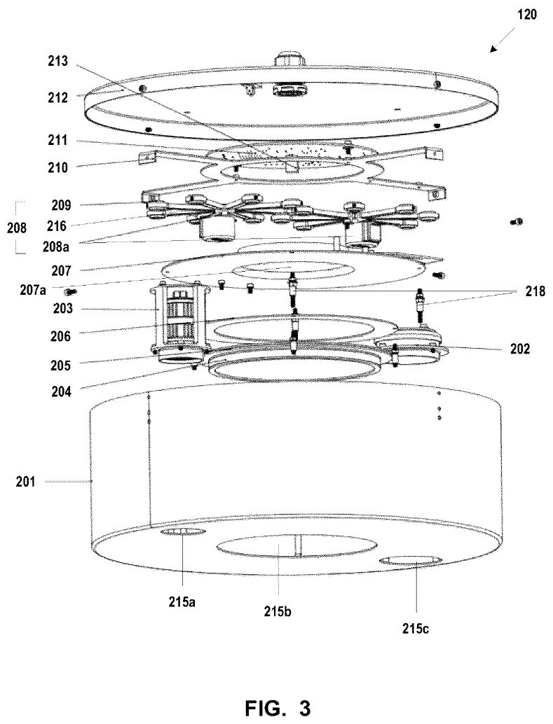

FIG. 3A shows an exploded view of a photonic sensor 120 according to at least one embodiment described herein.

As noted above, photonic sensor 120 is configured to emit an excitation pulse of light towards a portion of a plant (also referred to herein as a target area of the plant) and, subsequently, receive fluorescent light re-emitted by a molecule (e.g. chlorophyll) present in the plant. In at least one example, chlorophyll molecules present in the plant re-emit fluorescent light as they return from an excited state (initiated by the light pulse generated by the sensor 120) to a non-excited state. As noted above, characteristics of the fluorescent light re-emitted by the molecules present in the portion of the plant can provide information about the molecular activity of the plant. For example, characteristics of the fluorescent light may indicate a concentration and/or an activity of the molecule in the plant.

Photonic sensor 120 is configured to measure various characteristics of the fluorescent light and provide data including these characteristics to the computing device 110.

Photonic sensor 120 includes a housing 201. Housing 201 houses and secures the other parts of the photonic sensor 120, described in greater detail below. For example, housing 201 secures camera 203 that, for example, is configured to capture images of the plant. For example, camera 203 may be configured to capture images of a canopy of the plant for post analysis.

In at least one embodiment housing 201 is configured (e.g. has a geometric internal configuration) to provide for each of Fresnel protector 206, wavelength filter support 207 and printed circuit board (PCB) support 210 to be centered within housing 201.

Housing 201 includes a series of openings 215 in an underside thereof to provide for light to be emitted from and received by various parts of the photonic sensor 120. For example, opening 215a provides for camera 203 to capture images of the plant while the camera 203 is positioned within housing 201.

Photonic sensor 202 also includes one or more excitation pulse generator 202. Excitation pulse generator 202 are responsible for generating pulses of light responsible for exciting at least a portion of the plant. In at least one embodiment, excitation pulse generator 202 includes at least one light emitting diode (LED) that activates at a predetermined frequency and a predetermined pulse duration to instigate a light response from the plant.

In at least one embodiment, excitation pulse generator 202 includes four LEDs.

In at least one embodiment, excitation pulse generator 202 includes a data converter (not shown) that receives a signal from the computing device 110 instructing the excitation pulse generator 202 to generate a pulse.

In at least one embodiment, the predetermined frequency is in a range of about 5 to about 500 pulses per second, or in a range of about 50 to about 200 per second, or about 100 pulses per second.

In at least one embodiment, predetermined pulse duration is in a range of about 1 to about 10 microseconds or is about 5 microseconds.

In response to being excited by the excitation pulse of light emitted from the excitation pulse generator 202, the plant response in a form of fluorescence is then capture by P5.

In at least one embodiment, the camera 203 may be a Sony IMX477 sensor of 13.3 Mega pixels for wide angle and high-resolution photo or video capture. In at least one embodiment. the camera can be controlled via wired communication protocols or wireless communication protocols.

Camera 203 may also be configured to record videos of the plant (e.g. in high resolution, such as but not limited to 4 k or 5 k resolution) as directed by a user. For example, camera 203 may be controllable using computing device 110. In at least one embodiment, camera 203 may have an interchangeable lens to provide for high resolution video recording and photo capture. This may provide, for example, for NDVI measurement, plant disease and biomass evolution monitoring during growth cycle and other forms of image processing. In at least one embodiment, interchangeability of the lens may provide for modifying a level of detail and/or sharpness of the images.

In at least one embodiment, photonic sensor 120 includes protector 204. In at least one embodiment, protector 204 may be glass, such as but not limited to a chemically strengthened glass. In at least one embodiment, the protector 204 may be a piece of Gorilla™ glass. In at least one embodiment, protector 204 has high shock and wear resistance (e.g. higher shock and wear resistance than traditional float glass). Protector 204 is an optional feature.

In at least one embodiment, photonic sensor 120 includes a lens 205 such as but not limited to a Fresnel lens 205. Lens 205 is configured to receive a fluorescent light pulse from the plant emitted by the plant in response to the excitation pulse from excitation pulse generator 202. In at least one embodiment, the Fresnel lens 205 is shaped to provide for the lens 205 to be positioned in a flat orientation (e.g. not concave or convex) and provide for the light pulse received from the plant to be focused at a focal point.

In at least one embodiment, the photonic sensor 120 includes a fixation plate 206 meant to secure both the optional protector 204 and the lens 205 to housing 201. Fixation plate 206 is generally positioned upward of both the optional protector 204 and the lens 205.

In at least one embodiment, the photonic sensor 120 includes a wavelength filter support 207 positioned below one or more optical filters 209. Wavelength filter support 207 generally has a disc-like shape and defines a central opening 207a therethrough. Opening 207a is sized and shaped to provide for the pulse of light from the plant to pass therethrough. Wavelength filter support 207 couples to housing 201 and adjustably supports filter assembly 208, including motors 208a (e.g. step motors). In this manner, the position of optical filters 209 (via filter housing 216) can be vertically adjusted to be positioned at the focal point of the photonic sensor 120, as needed. The focal point is determined by Fresnel lens 205.

In at least one embodiment, wavelength filter support 207, which supports motors 208a, is supported by a plurality (e.g. four) flange nuts 218 screwed at a predetermined height by removable spacers. The sitting height of wavelength filter support 207 can be manually adjusted by rotating the flange nuts. In at least one embodiment, the two rotations of the nuts may equate to one mm of vertical displacement of wavelength filter support 207.

A plurality of optical filters 209 are positioned within a filter housing 216. Each of the optical filters 209 selectively transmits one portion of the optical spectrum while rejecting other portions of the optical spectrum. Collectively, the plurality of optical filters 209 provide for photonic sensor 120 to be able to detect several wavelengths without a user having to manually change the optical filters 209.

In at least one embodiment, the optical filters 209 are selected based on wavelength spikes corresponding to different molecules of the plant, such as but not limited to Chlorophyl A and B, Carotenoids, Phycocyanin and Phycoerythrin and the like.

In at least one embodiment, each of the optical filters 209 has a disc-like shape and is mounted in an anodized ring having a diameter of about 12.5 mm and a full width-half max of 10±2 nm (around the desired wavelength of light).

In at least one embodiment, filter assembly 208 is configured to be vertically adjustable to position optical filters 209 at a focal point of the photonic sensor 120. Filter assembly 208 includes step motors 208a, filter housing 216 and the plurality of optical filters 209. In the embodiment shown in FIG. 3, filter assembly 208 includes two step motors 208a, each coupled to a separate filter housing 216.

In at least one embodiment, the step motors 208a each have less than about 0.1-degrees of step angle.

In at least one embodiment, each filter housing 216 includes eight branches equally spaced apart in a circular shape. Each branch of filter housing 216 is configured to support one optical filter 209. Together, the two filter housings 216 support 16 different optical filters 209. Each step motor 208a is configured to rotate a filter housing 216 (e.g. about a vertical axis) to provide for each optical filter 209 of each filter housing 216 to be positioned within a path of the light pulse received from the plant. In at least one embodiment, filter assembly 208 includes step motors 208a and two filter housings 216 that rotate simultaneously in opposite directions (e.g. about a vertical axis). Accordingly, the step motors 208a each provide for changing between various optical filters. Further, the step motors 208a also provide for accurate positioning of various optical filters 209 at the focal point to provide for the photonic filter 120 to read 16 different wavelengths.

In at least one embodiment, photonic sensor 120 includes a PCB support plate 210. PCB support plate supports PCB 211. In at least one embodiment, PCB support plate 210 is shaped to provide for the PCB 211 to be centered within housing 201, to inhibit movement of the PCB 211 relative to housing 210 and to provide for additional PCBs 211 to be added to the photonic sensor 120.

In at least one embodiment, photonic sensor 120 includes a PCB 211. PCB 211 controls circuitry of the excitation pulse generator 202. In at least one embodiment, PCB 211 hosts a photodiode 213 that is used for fluorescence reading. After reading a fluorescence of the light pulse received from the plant, the photodiode 213 sends a resulting signal to computing device 110.

In at least one embodiment, photonic sensor 120 includes a housing cap 212 that couples to housing 201 and covers the other components of the photonic sensor 120.

In at least one embodiment, photodiode 213 measures an intensity of the pulse of light received from the plant at the fluorescence provided by the optical filters 209 positioned within the pathway of the pulse of light from the plant (and at the focal length). In at least one embodiment, optical filters 209 selectively transmit light within a portion of the optical spectrum that has been determined to indicate a molecular activity of the plant while rejecting light of other portions of the optical spectrum. Photodiode 213 then measures a light intensity of the pulse of light from the plant at the selected wavelength. An electric signal from the photodiode 213 indicating the intensity of the light at the selected wavelength can then be sent to a data converter (not shown) that digitalizes the signal and transmits it to the computing device 110.

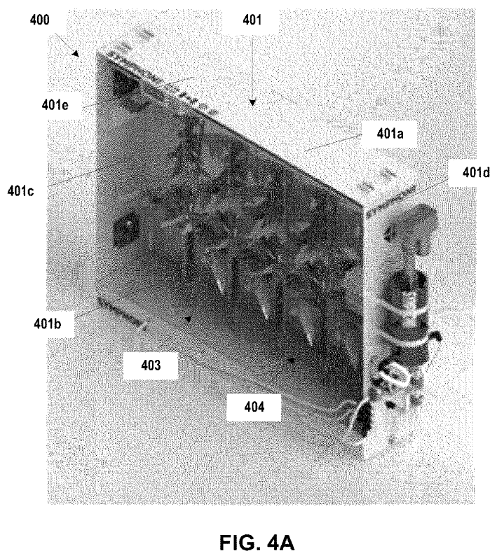

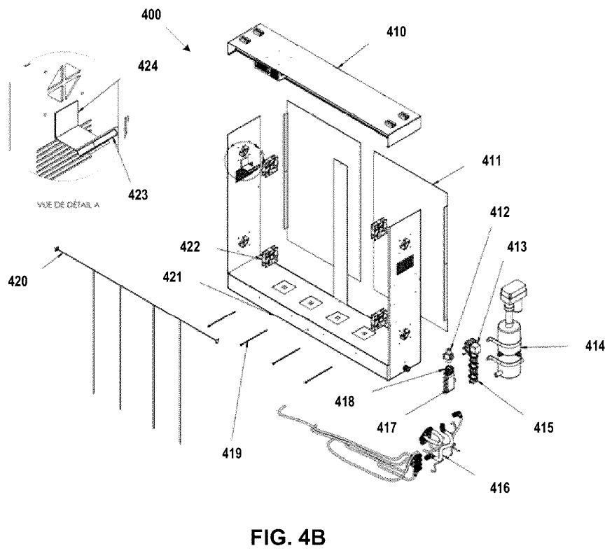

Turning now to FIG. 4A, a perspective view of a growth chamber 400 according to one embodiment described herein is shown therein. Growth chamber 400 is configured for hydroponic growth of plants. Growth chamber 400 included a housing 401 including a top plate 401a, a bottom plate 401b, two opposed side plates 401c, 401d and a rear plate 401e. Growing chamber 400 has a front opening 403 configured to provide access to a cavity 404 defined by the top plate 401a, bottom plate 401b, two opposed side plates 401c, 401d and rear plate 401e. Cavity 404 houses at least one plant, as shown in FIG. 4A.

Each of the growth chambers described herein may include one or more of the sensors described above, including but not limited to the photonic sensors 120 or environmental sensors 130. Further, each of the growth chambers described herein may have individual components controlled by the controller 140 described above to provide for autonomous control of the growth of plant(s) housed in the chamber.

FIG. 4B is an exploded view of the growth chamber 400 of FIG. 4A. Therein, lighting assembly 410 is positioned at or near top plate 401a and configured to direct light downwardly on the plant(s).

In at least one embodiment, rear plate 401e may include one or more backing plates 411. In at least one embodiment, the backing plates 411 may be plexiglass plates.

In at least one embodiment, the growth chamber 400 may include a filling system 412. Filling system 412 may be coupled to a peristaltic pump 413 configured to mix the proper amount of nutrients with the water from water tank 414. Valves 415 may be used to control the flow of water from the water tank 414. Water travels downwardly from the water tank 414 through a set of piping 415 to a bottom portion of the plant(s).

In at least one embodiment, the growth chamber 400 may include a water dispatcher 417 and a return pump 418.

In at least one embodiment, the growth chamber 400 may include water needles 419 for delivering the water to the bottom portion of the one or more plants. In at least one embodiment, the growth chamber 400 may include plant holders 420 to support the one or more plants in a vertical orientation.

In at least one embodiment, the growth chamber 400 may include water basin 421 to collect any excess water within the cavity 404. Water basin 421 is generally positioned below the plants.

In at least one embodiment, the growth chamber 400 may include one or more fans 422 to increase air circulation within cavity 404.

In at least one embodiment, the growth chamber 400 may include a camera 423. In at least one embodiment, the camera 423 may be supported within the housing 401 by an angular support 424 and used to capture images (e.g. pictures and/or video) of the plants, such as but not limited to the canopy of the plants.

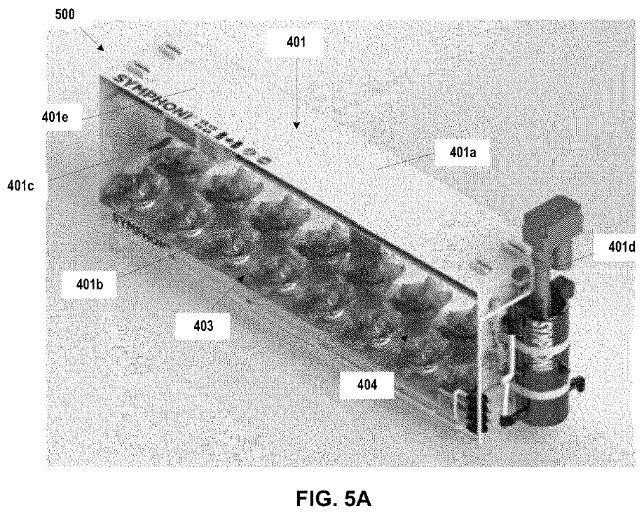

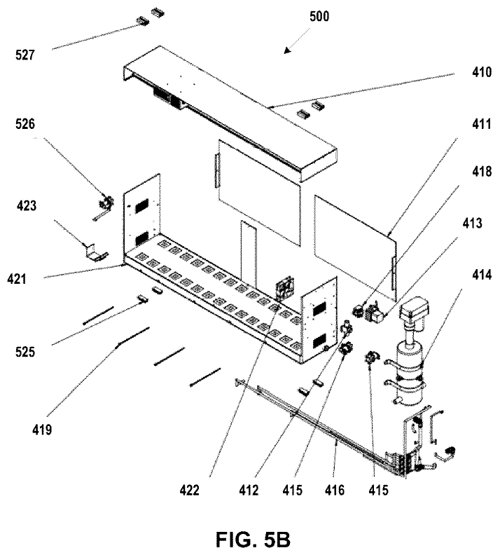

FIG. 5A is a perspective view of another growth chamber 500, according to one embodiment described herein. Growth chamber 500 is similar to growth chamber 400 and like components are represented with the same numerals as used with reference to growth chamber 400.

Growth chamber 500 is also configured for hydroponic growth of plants. As described previously with respect to growth chamber 400, growth chamber 500 includes a housing 401 including a top plate 401a, a bottom plate 401b, two opposed side plates 401c, 401d and a rear plate 401e. Growing chamber 500 has a front opening 403 configured to provide access to a cavity 404 defined by the top plate 401a, bottom plate 401b, two opposed side plates 401c, 401d and rear plate 401e. Cavity 404 houses at least one plant, as shown in FIG. 5A.

FIG. 5B is an exploded view of the growth chamber 500 of FIG. 5A. Growth chamber 500 may be appropriate for growing plants that are shorter than plants that may be housed in growth chamber 400. Therein, lighting assembly 410 is positioned at or near top plate 401a and configured to direct light downwardly on the plant(s).

In at least one embodiment, rear plate 401e may include one or more backing plates 411. In at least one embodiment, the backing plates 411 may be plexiglass plates.

In at least one embodiment, the growth chamber 500 may include a filling system 412. Filling system 412 may be coupled to a peristaltic pump 413 configured to mix the proper amount of nutrients with the water from water tank 414. Valves 415 may be used to control the flow of water from the water tank 414. Water travels downwardly from the water tank 414 through a set of piping 415 to a bottom portion of the plant(s).

In at least one embodiment, the growth chamber 500 may include a return pump 418.

In at least one embodiment, the growth chamber 500 may include water needles 419 for delivering the water to the bottom portion of the one or more plants.

In at least one embodiment, the growth chamber 500 may include water basin 421 to collect any excess water within the cavity 404. Water basin 421 is generally positioned below the plants.

In at least one embodiment, the growth chamber 500 may include one or more fans 422 to increase air circulation within cavity 404.

In at least one embodiment, the growth chamber 500 may include a camera 423. In at least one embodiment, the camera 423 may be supported within the housing 401 by an angular support 424 and used to capture images (e.g. pictures and/or video) of the plants, such as but not limited to the canopy of the plants.

In at least one embodiment, the growth chamber 500 may include a lower rail 525 and/or upper rail 527. In at least one embodiment, lower rail 525 and/or upper rail 527 may be used to stack growing chambers 500 on top or one another and secure stacked growing chambers 500 to one another.

In at least one embodiment, the growth chamber 400 may include an oxygen valve 526. Oxygen valve 526 may be used to control oxygen deliver to the cavity 404.

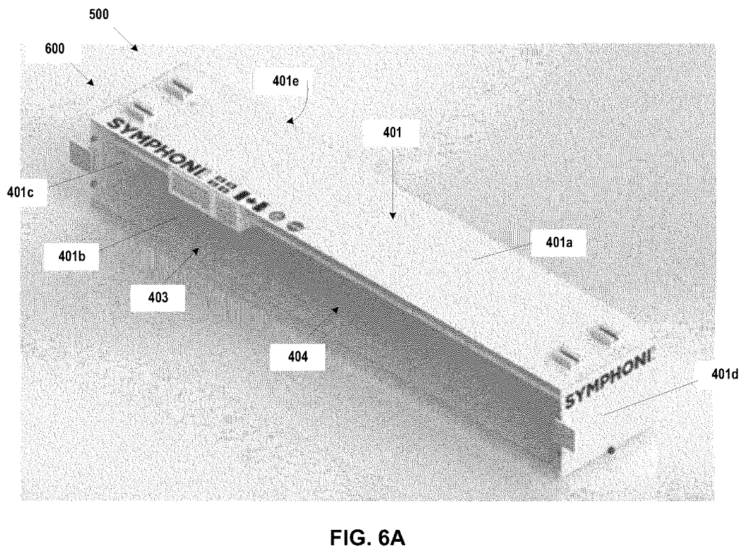

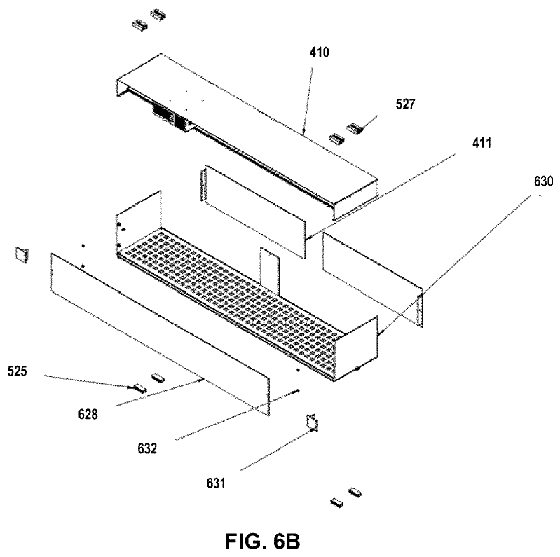

FIG. 6A is a perspective view of another growth chamber 600, according to one embodiment described herein. Growth chamber 600 may be appropriate for growing seeds or seedlings. Growth chamber 600 is similar to growth chambers 400 and 500 and like components are represented with the same numerals as used herein with reference to growth chambers 400 and 500.

FIG. 6B is an exploded view of the growth chamber 600 of FIG. 6A. Therein, a lighting assembly 410 is positioned at or near top plate 401a and configured to direct light downwardly on the plant(s).

In at least one embodiment, the growth chamber 600 may include a lower rail(s) 525 and/or upper rail(s) 527. In at least one embodiment, lower rail 525 and/or upper rail 527 may be used to stack growing chambers 600 on top or one another and secure stacked growing chambers 600 to one another.

Growth chamber 600 is also configured for hydroponic growth of plants. As described previously with respect to growth chamber 400, growth chamber 600 includes a housing 401 including a top plate 401a, a bottom plate 401b, two opposed side plates 401c, 401d and a rear plate 401e. Growing chamber 600 has a front opening 403 configured to provide access to a cavity 404 defined by the top plate 401a, bottom plate 401b, two opposed side plates 401c, 401d and rear plate 401e. Cavity 404 houses at least one plant, as shown in FIG. 6A.

In at least one embodiment, rear plate 401e of growing chamber 600 may include one or more backing plates 411. In at least one embodiment, the backing plates 411 may be plexiglass plates. In at least one embodiment, growing chamber 600 may include a front plate 628. Front plate 628 may also be a plexiglass plate and may provide for sealing cavity 404 to provide a more controlled environment than growing chambers 400 and 500.

In at least one embodiment, growing chamber 600 may include a seed chamber main body 630. Seed chamber main body 630 may be configured to house a plurality of seeds.

In at least one embodiment, growing chamber 600 may include one or more magnetic holder supports 631. Magnetic holder supports 631 hold one or more magnetic holders 632. Magnetic holders 632 are configured to magnetically hold the front plate 628 to the seed chamber main body 630.

While the applicant's teachings described herein are in conjunction with various embodiments for illustrative purposes, it is not intended that the applicant's teachings be limited to such embodiments as the embodiments described herein are intended to be examples. On the contrary, the applicant's teachings described and illustrated herein encompass various alternatives, modifications, and equivalents, without departing from the embodiments described herein, the general scope of which is defined in the appended claims.

What is claimed is:

1. A photonic sensor comprising:
an excitation pulse generator configured to generate an excitation pulse of light and direct the excitation pulse of light towards a target area of a plant.
a lens configured to receive fluorescent light from the target area of the plant and direct the fluorescent light to a focal point;
a plurality of optical filters, each optical filter configured to selectively transmit a selected wavelength range of the fluorescent light from the target area of the plant, the selected wavelength range indicates an activity and/or a concentration of at least one molecule of the plant; and
a photodiode configured to determine an intensity of the fluorescent light having the selected wavelength range and convert the measured intensity to a digital signal to be transmitted as molecular activity data to a computing device.

2. The photonic sensor of claim 1, wherein each of the optical filters is selected based on wavelength spikes corresponding to different molecules of the plant.

3. The photonic sensor of claim 2, wherein the molecules of the plant are selected from Chlorophyl A and B, Carotenoids, Phycocyanin and Phycoerythrin and others.

4. The photonic sensor of claim 1 further comprising a filter assembly comprising a housing configured to support each of the plurality of optical filters, the filter assembly being configured to position each of the optical filters at or near the focal point.

5. The photonic sensor of claim 4, wherein the filter assembly further comprises:
at least one motor coupled to the housing and configured to rotate the housing about a vertical axis.

6. The photonic sensor of claim 5, wherein the filter assembly comprises:
two step motors;
two filter housings, each filter housing being coupled to one of the motors and configured to rotate about a vertical axis; and
eight optical filters housed in each of the filter housings.

7. The photonic sensor of claim 6, wherein the filter housings are configured to rotate simultaneously in opposite directions.

8. The photonic sensor of claim 6, wherein each filter housing is configured to rotate each optical filter into a path of the light from the plant at the focal point.

9. The photonic sensor of claim 6, wherein the filter assembly is adjustable to position the optical filters at the focal point.

10. A system for controlling growth of a plant, the system comprising
a photonic sensor configured to:
direct an excitation pulse of light towards a target area of the plant;
receive fluorescent light from the target area of the plant;
selectively transmit a selected wavelength range of the fluorescent light from the target area of the plant, the selected wavelength range indicating an activity and/or a concentration of at least one molecule of the plant;
determine an intensity of the fluorescent light having the selected wavelength range;
convert the measured intensity to a digital signal;
transmit the digital signal to a computing device as plant molecular activity data; and
a computing device communicatively coupled to the photonic sensor, the computing device configured to:
receive the plant molecular activity data from the photonic sensor, the plant molecular activity data indicating molecular activity or a molecular concentration of one or more molecules;
receive environmental data associated with an environment around the plant; and
based on the plant molecular activity data, determine a setting of one or more conditions of the environment that improves health of the plant.

11. The system of claim 10, further comprising at least one environmental sensor configured to:
measure at least one environmental factor; and
transmit environmental data indicating the environmental factor to the computing device.

12. The system of claim 11, wherein the computing device is configured to determine the command based on the plant molecular activity data and the environmental data.

13. A method of controlling growth of a plant, the method comprising:
directing an excitation pulse of light towards a target area of the plant;
receiving fluorescent light from the target area of the plant;
selectively transmitting a selected wavelength range of the fluorescent light from the target area of the plant, the selected wavelength range indicating an activity and/or a concentration of at least one molecule of the plant;
determining an intensity of the fluorescent light having the selected wavelength range;
converting the measured intensity to a digital signal; and
transmitting the digital signal to a computing device as plant molecular activity data.

14. Any and all features of novelty and inventiveness described, referred to, shown as examples, or otherwise described herein.
